(19) United States
(12) Patent Application Publication
(10) Pub. No.: US 2013/0205262 A1
(43) Pub. Date: Aug. 8, 2013

(54) METHOD AND APPARATUS FOR ADJUSTING A PARAMETER

(71) Applicant: Eero Matti Juhani Kauranen, Salo (FI)

(72) Inventor: Eero Matti Juhani Kauranen, Salo (FI)

(73) Assignee: NOKIA CORPORATION, Espoo (FI)

(21) Appl. No.: 13/575,305

(22) PCT Filed: Feb. 1, 2011
(86) PCT No.: PCT/IB11/50442

§ 371 Date: Oct. 4, 2012

(30) Foreign Application Priority Data
Feb. 1, 2010 (US) 12698016

(51) Int. Cl. G06F 3/048

(52) U.S. Cl. CPC G06F 3/048
USPC 715/863

(57) ABSTRACT

A method comprising receiving an indication of a continuous stroke input, setting an adjustment magnitude based on a predetermined adjustment magnitude, determining that the continuous stroke input comprises a first adjustment magnitude input, adjusting the adjustment magnitude based on the magnitude adjustment input, determining that the continuous stroke input comprises a first adjustment input, and adjusting a parameter based on the adjustment magnitude and the first adjustment input is disclosed.

### TECHNICAL FIELD

The present application relates generally to input for adjusting a parameter.

### BACKGROUND

As electronic devices become more pervasive in the lives of users, there are an increasing number of scenarios where a user may desire to simplify, quicken, and/or reduce intrusiveness of interaction with the device.

### SUMMARY

Various aspects of examples of the invention are set out in the claims.

An apparatus, comprising: a processor; memory including computer program code, the memory and the computer program code configured to, working with the processor, cause the apparatus to perform at least the following: receiving an indication of a continuous stroke input, setting an adjustment magnitude based on a predetermined adjustment magnitude, determining that the continuous stroke input comprises a first adjustment magnitude input, adjusting the adjustment magnitude based on the magnitude adjustment input, determining that the continuous stroke input comprises a first adjustment input, and adjusting a parameter based on the adjustment magnitude and the first adjustment input is disclosed.

A method comprising receiving an indication of a continuous stroke input, setting an adjustment magnitude based on a predetermined adjustment magnitude, determining that the continuous stroke input comprises a first adjustment magnitude input, adjusting the adjustment magnitude based on the magnitude adjustment input, determining that the continuous stroke input comprises a first adjustment input, and adjusting a parameter based on the adjustment magnitude and the first adjustment input is disclosed.

A computer-readable medium encoded with instructions that, when executed by a computer, perform: receiving an indication of a continuous stroke input, setting an adjustment magnitude based on a predetermined adjustment magnitude, determining that the continuous stroke input comprises a first adjustment magnitude input, adjusting the adjustment magnitude based on the magnitude adjustment input, determining that the continuous stroke input comprises a first adjustment input, and adjusting a parameter based on the adjustment magnitude and the first adjustment input is disclosed.

### BRIEF DESCRIPTION OF THE DRAWINGS

For a more complete understanding of embodiments of the invention, reference is now made to the following descriptions taken in connection with the accompanying drawings in which:

FIGS. 1A-1G are diagrams relating to a continuous stroke input for adjustment according to at least one example embodiment;

FIGS. 2A-2E are diagrams illustrating a continuous stroke input for adjustment according to at least one example embodiment;

FIGS. 3A-3B are diagrams illustrating visual representations a parameter relating to time according to at least one example embodiment;

FIG. 4 is a flow diagram showing a set of operations for parameter adjustment according to an example embodiment;

FIG. 5 is a flow diagram showing a set of operations for parameter adjustment according to an example embodiment;

FIGS. 6A-6E are diagrams illustrating input associated with a touch display according to at least one example embodiment; and

FIG. 7 is a block diagram showing an apparatus according to an example embodiment.

### DETAILED DESCRIPTION OF THE DRAWINGS

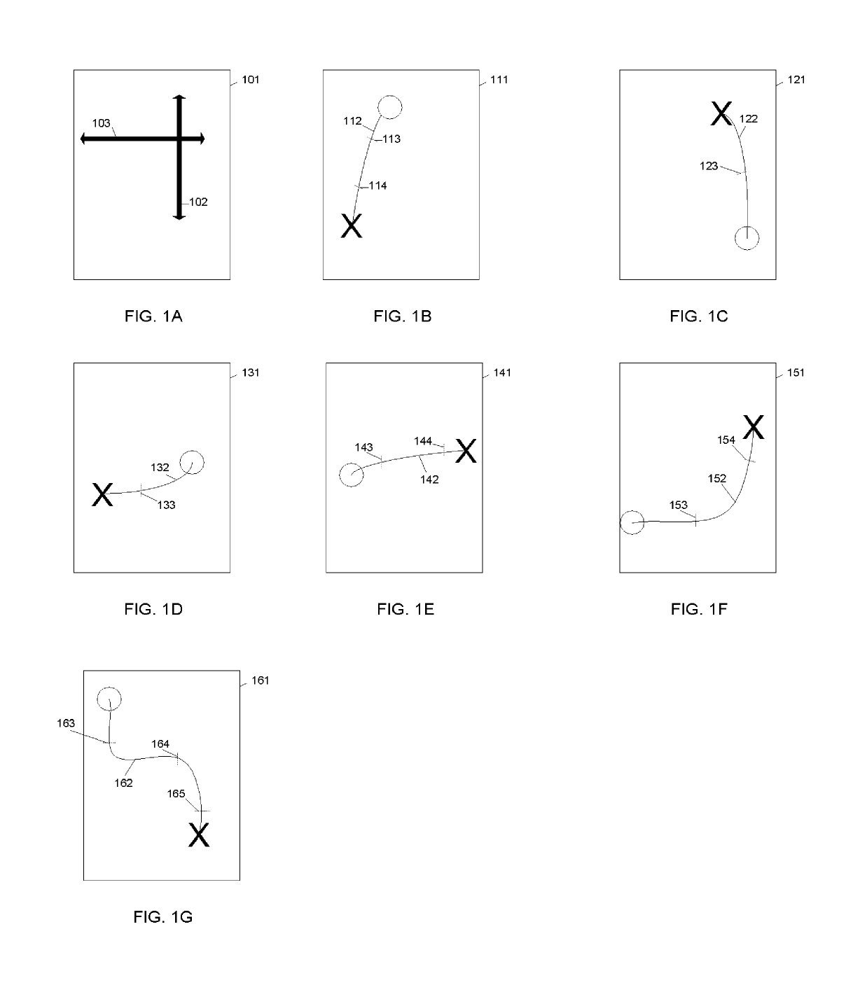

At least one embodiment and its potential advantages are understood by referring to FIGS. 1A through 7 of the drawings.

As electronic devices become more pervasive in the lives of users, there are an increasing number of scenarios where a user may desire to simplify, quicken, and/or reduce intrusiveness of interaction with the device. For example, a user may acquire a high level of familiarity with an operation. Under such circumstances, the user may be accustomed to a pattern of operations, and require little, if any, prompting from the device to perform the operation. In another example, a user may be performing an action that is independent of the device, such as carrying on a conversation, walking, reading, and/or the like. In such an example, the user may desire to perform an operation without viewing the device. Under such circumstances, the user may still desire to perceive feedback on the operation, such as to allow the user to understand whether the operation was performed as the user desired.

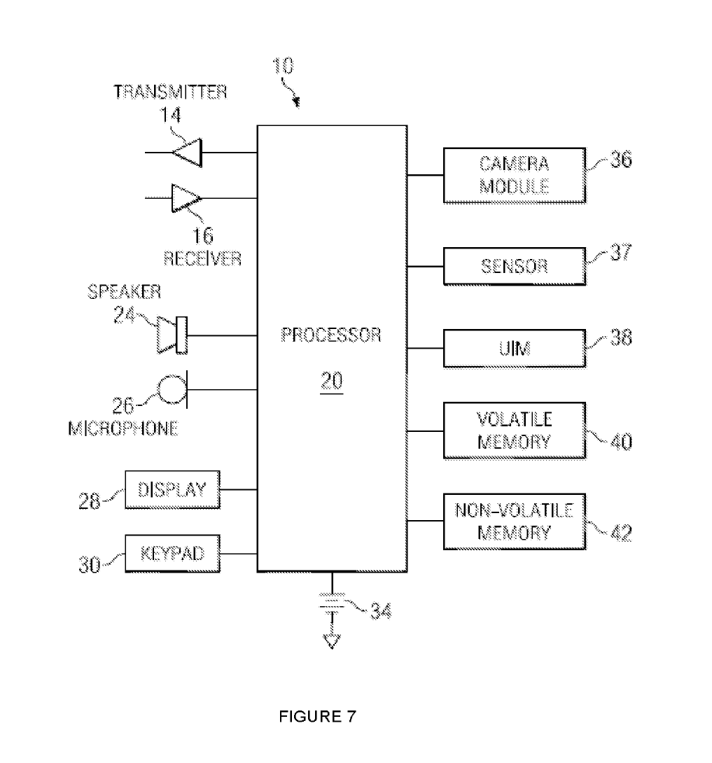

FIGS. 1A-1G are diagrams relating to a continuous stroke input for adjustment according to at least one example embodiment. The examples of FIGS. 1A-1G are merely examples, and do not limit the scope of the claims. For example, one or more axis may vary, arrangement may vary, continuous stroke input may vary, size may vary, orientation may vary, and/or the like. The examples of FIGS. 1A-1G illustrate inputs in relation to an input area. An input area may be a touch display, such as display 28 of FIG. 7, a digitizer tablet, and/or the like.

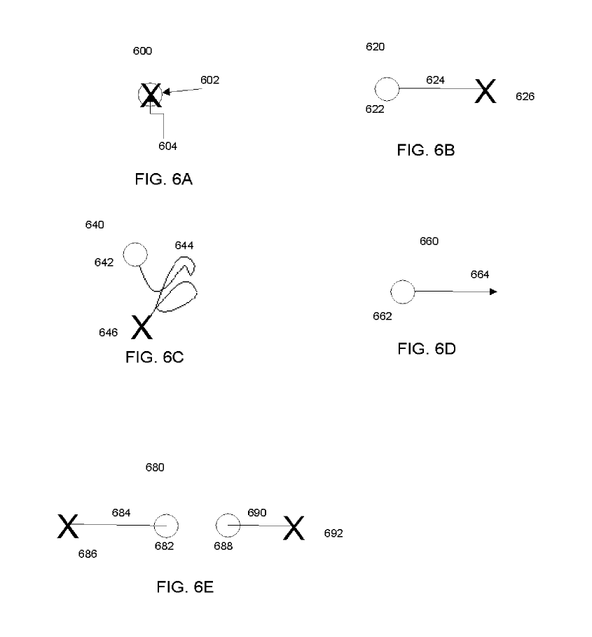

In an example embodiment, a user performs a continuous stroke input to adjust a parameter. The continuous stroke input may be similar as described with reference to FIGS. 6A-6E. The parameter may be a setting, a variable, a data element, and/or the like. The parameter may comprise other parameters. For example, a parameter related to time may comprise an hour parameter and a minute parameter. The parameter may have a value such that the parameter may be adjusted in a sequential manner. For example, the parameter may be an integer, an enumeration, and/or the like.

The user may desire to reduce the amount of input performed when adjusting a parameter. To accomplish this, the user may desire to adjust a parameter by varying magnitude. For example, if the user desires to adjust a parameter by eleven, the user may desire to adjust the parameter by ten and by one instead of performing eleven adjustments of the parameter by one. Under such circumstances, the user may desire to be able to change the magnitude of parameter adjustment along with the parameter adjustment. Under such circumstances, the user may desire to perform a single continuous stroke input that is capable of adjusting the parameter by a magnitude, adjusting the magnitude to a different magnitude, and adjusting the parameter by the different magnitude. Without limiting the scope of the invention in any way, at least one possible technical effect of such a continuous stroke input may be to reduce the amount of input a user performs for adjusting a parameter, and reducing the amount of input an apparatus processes associated with adjusting a parameter.

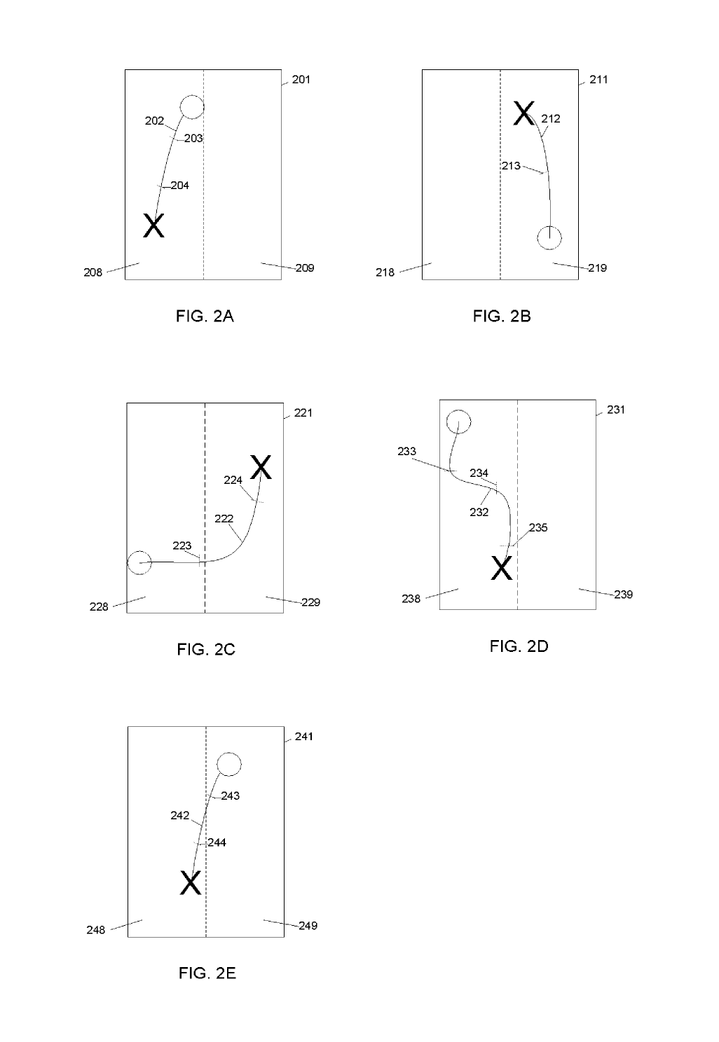

In an example embodiment, the continuous stroke input comprises an adjustment input and an adjustment magnitude input. The adjustment input is an input indicating a desire to perform an adjustment of a parameter. The adjustment magnitude input is an input indicating a desire to adjust the magnitude of a parameter adjustment. For example, where an initial adjustment magnitude is 1, a user may cause an apparatus to adjust a parameter by eleven by performing a continuous stroke input that comprises a first adjustment input indicating a single magnitude adjustment, followed by an adjustment magnitude input indicating magnitude adjustment from one to ten, followed by an adjustment input indicating a single magnitude adjustment. Such a continuous stroke input may be similar to continuous stroke input 152 of FIG. 1G, continuous stroke input 232 of FIG. 2D, and/or the like.

FIG. 1A illustrates an adjustment axis 102 in relation to a magnitude adjustment axis 103 and an input area 101 according to at least one example embodiment.

In an example embodiment, an apparatus utilizes the adjustment axis 102 when determining an adjustment input. The apparatus may evaluate a part of a continuous stroke input to determine whether the part of the continuous stroke input is substantially parallel to the adjustment axis 102. If the apparatus determines that the part of the continuous stroke input is substantially parallel to the adjustment axis 102, the apparatus may determine that the part of the continuous stroke input is an adjustment input. The adjustment axis 102 may have an associated positive direction, such that when the apparatus determines that an adjustment input is along the positive direction of the adjustment axis 102, the apparatus increases the parameter when adjusting the parameter. Furthermore, when the apparatus determines that an adjustment input is along a direction opposite to the positive direction of the adjustment axis 102, the apparatus decreases the parameter when adjusting the parameter. For example, the positive direction of the adjustment axis 102 may be downward. In such an example, the apparatus may increase the parameter when adjusting the parameter in response to determination that an adjustment input is in a downward direction.

Determination of substantially parallel may vary across embodiments and/or circumstances. For example, an apparatus may determine that a part of a continuous stroke input that varies within a tolerance factor is substantially parallel. The tolerance factor may be based upon a predetermined value, a dynamic value, and/or the like. For example, an apparatus may have a large predetermined tolerance factor, such as 30 degrees, 45 degrees, and/or the like, for example, to allow for angular variation from a rapidly performed user input. In another example, the apparatus may vary tolerance factor based, at least in part on the usage of the apparatus. In such an example, the apparatus may utilize a larger tolerance factor for finger input than for stylus input, a larger tolerance factor when the apparatus is in motion than when the apparatus is stationary, and/or the like.

In an example embodiment, an apparatus utilizes the magnitude adjustment axis 103 when determining an adjustment input. The apparatus may evaluate a part of a continuous stroke input to determine whether the part of the continuous stroke input is substantially parallel to the magnitude adjustment axis 103. If the apparatus determines that the part of the continuous stroke input is substantially parallel to the magnitude adjustment axis 103, the apparatus may determine that the part of the continuous stroke input is a magnitude adjustment input. The magnitude adjustment axis 103 may have an associated positive direction, such that when the apparatus determines that a magnitude adjustment input is along the positive direction of the magnitude adjustment axis 103, the apparatus increases the adjustment magnitude when adjusting the adjustment magnitude. Furthermore, when the apparatus determines that an adjustment input is along a direction opposite to the positive direction of the magnitude adjustment axis 103, the apparatus decreases the adjustment magnitude when adjusting the adjustment magnitude. For example, the positive direction of the magnitude adjustment axis 103 may be rightward. In such an example, the apparatus may increase the adjustment magnitude when adjusting the adjustment magnitude in response to determination that a magnitude adjustment input is in a rightward direction.

In an example embodiment, an apparatus determines an adjustment magnitude to be utilized in adjusting the parameter. The apparatus may set an adjustment magnitude based, at least in part, on a predetermined magnitude. The predetermined adjustment magnitude may be a stored value, may be a default value, may be determined based upon an aspect of the continuous stroke input, may be determined based upon an environmental factor related to the apparatus, and/or the like. The apparatus may base subsequent magnitude adjustment, at least in part, on the predetermined adjustment magnitude.

In an example embodiment, an apparatus adjusts the adjustment magnitude based, at least in part, on the magnitude adjustment input. The apparatus may adjust the adjustment magnitude based, at least in part, on speed of the magnitude adjustment input, length of the magnitude adjustment input, and/or the like. For example, the apparatus may adjust the adjustment magnitude to a greater extent for a quick magnitude adjustment input than for a less quick magnitude adjustment input. In another example, the apparatus may adjust the magnitude adjustment to a greater extent for a long magnitude adjustment input than for a less long magnitude adjustment input. In such an example, the apparatus may adjust the adjustment magnitude in response to a determination that the magnitude adjustment input has exceeded a length, has exceeded a length since a previous adjustment, and/or the like. For example, the apparatus may adjust the magnitude adjustment for each centimeter of the magnitude adjustment input. In an example embodiment, the apparatus adjusts the adjustment magnitude by increasing the adjustment magnitude based on determination that the magnitude adjustment input is in a substantially positive direction along the magnitude adjustment axis, or by decreasing the adjustment magnitude based on determination that the magnitude adjustment input is in a substantially opposite direction to the positive direction along the magnitude adjustment axis. The apparatus may adjust the adjustment magnitude based on a predetermined value, a predetermined factor, a calculation, and/or the like. For example, the apparatus may increase the adjustment magnitude by a factor of ten. In another example, the apparatus may decrease the magnitude adjustment from one minute to one second. In an example embodiment, the apparatus adjusts the adjustment magnitude without regard for position of the magnitude adjustment input. For example, the apparatus may adjust the adjustment magnitude without regard for contact input position, release input position, movement input position, and/or the like. In such an example, the apparatus may base adjustment of the adjustment magnitude on an aspect of the magnitude adjustment input that is independent of position, such as length, speed, and/or the like. In an example embodiment, the apparatus may limit magnitude adjustment to be within a threshold value. For example, the apparatus may avoid decreasing an adjustment magnitude below one second. In another example, the apparatus may avoid increasing an adjustment magnitude above one hundred. The apparatus may use such limitation to avoid adjusting the magnitude adjustment beyond a threshold value. There may be a lower threshold value and/or an upper threshold value, that limits decreasing and/or increasing, respectively.

In an example embodiment, an apparatus adjusts a parameter based, at least in part, on the adjustment input. The apparatus may adjust the parameter based, at least in part, on speed of the adjustment input, length of the adjustment input, and/or the like. For example, the apparatus may adjust the parameter to a greater extent for a quick adjustment input than for a less quick adjustment input. In another example, the apparatus may adjust the parameter to a greater extent for a long adjustment input than for a less long adjustment input. In such an example, the apparatus may adjust the parameter in response to a determination that the adjustment input has exceeded a length, has exceeded a length since a previous adjustment, and/or the like. For example, the apparatus may adjust the parameter for each centimeter of the adjustment input. In an example embodiment, the apparatus adjusts the parameter by increasing the parameter based on determination that the adjustment input is in a substantially positive direction along the adjustment axis, or by decreasing the parameter based on determination that the adjustment input is in a substantially opposite direction to the positive direction along the adjustment axis.

The apparatus may adjust the parameter based on the adjustment magnitude and the adjustment input. The apparatus may adjust the parameter by a multiple of the adjustment magnitude. For example, the apparatus may increase the parameter by the value of the adjustment magnitude. In another example, the apparatus may decrease the magnitude adjustment by two times the adjustment magnitude. In an example embodiment, the apparatus adjusts the parameter without regard for position of the adjustment input. For example, the apparatus may adjust the parameter without regard for contact input position, release input position, movement input position, and/or the like. In such an example, the apparatus may base adjustment of the parameter on an aspect of the adjustment input that is independent of position, such as length, speed, and/or the like. In an example embodiment, the apparatus may limit the parameter to be within a threshold value. For example, the apparatus may avoid decreasing a parameter below zero. In another example, the apparatus may avoid increasing a parameter above fifty-nine minutes. The apparatus may use such limitation to avoid adjusting the parameter beyond a threshold value. There may be a lower threshold value and/or an upper threshold value, that limits decreasing and/or increasing, respectively.

In an example embodiment, an apparatus may provide an indication that an adjustment, such as a parameter adjustment and/or an adjustment magnitude adjustment, has been performed. The indication may be visual and/or non-visual. A non-visual indication may be audible, tactile, and/or the like. An audible indication may be a beep, a click, a tone, a tune, a change in a tone, and/or the like. A tactile indication may be a bump, a vibration, a change in vibration, and/or the like. Without limiting the claims in any way, at least one possible technical advantage associated with providing a non-visual indication of an adjustment is allowing a user to perceive that an adjustment has been performed without viewing displayed information. In an example embodiment, the apparatus may provide a first non-visual indication associated with an adjustment being performed, and a second non-visual indication, which may differ from the first non-visual indication, associated with an adjustment reaching a threshold value and/or being prevented due to a threshold value. For example, the apparatus may provide a click for each adjustment performed, and a beep when the adjustment reaches a threshold value.

For purposes of clarity and consistency of examples, the examples of FIGS. 1A-1G relate to a vertical adjustment axis with a downward positive direction, and a horizontal magnitude adjustment axis with a leftward positive direction. However, such examples do not limit the scope of the claims in any way. For example, orientation and direction of axes may vary across embodiments and/or under varying circumstances.

FIG. 1B illustrates a continuous stroke input 112 for adjustment in relation to an input area 111 according to at least one example embodiment. Continuous stroke input 112 relates to an increasing adjustment input. In the example of FIG. 1B, marks 113 and 114 illustrate a point in continuous stroke input 112 associated with an adjustment. Therefore, in response to receiving continuous stroke input 112, an apparatus may adjust a parameter by two times an adjustment magnitude, or may adjust the parameter by the adjustment magnitude twice.

FIG. 1C illustrates a continuous stroke input 122 for adjustment in relation to an input area 121 according to at least one example embodiment. Continuous stroke input 122 relates to a decreasing adjustment input. In the example of FIG. 1C, mark 123 illustrates a point in continuous stroke input 122 associated with an adjustment. Therefore, in response to receiving continuous stroke input 122, an apparatus may adjust a parameter by an adjustment magnitude.

FIG. 1D illustrates a continuous stroke input 132 for adjustment in relation to an input area 131 according to at least one example embodiment. Continuous stroke input 132 relates to an increasing magnitude adjustment input. In the example of FIG. 1D, mark 133 illustrates a point in continuous stroke input 132 associated with an adjustment. Therefore, in response to receiving continuous stroke input 132, an apparatus may adjust a magnitude adjustment.

FIG. 1E illustrates a continuous stroke input 142 for adjustment in relation to an input area 141 according to at least one example embodiment. Continuous stroke input 142 relates to a decreasing magnitude adjustment input. In the example of FIG. 1E, marks 143 and 144 illustrate a point in continuous stroke input 142 associated with an adjustment. Therefore, in response to receiving continuous stroke input 142, an apparatus may adjust an adjustment magnitude by two adjustments, or may adjust the adjustment magnitude twice.

FIG. 1F illustrates a continuous stroke input 152 for adjustment in relation to an input area 151 according to at least one example embodiment. Continuous stroke input 152 relates to a continuous stroke input that comprises a decreasing magnitude adjustment input prior to a decreasing adjustment input. In the example of FIG. 1F, mark 153 illustrates a point in continuous stroke input 152 associated with an adjustment magnitude adjustment, and mark 154 illustrates a point in continuous stroke input 152 associated with a parameter adjustment. Therefore, in response to receiving continuous stroke input 152, an apparatus may adjust an adjustment magnitude, and then may adjust the parameter by the adjustment magnitude. For example, in response to receiving continuous stroke input 152, the apparatus may adjust the adjustment magnitude from one hour to fifteen minutes, and may adjust the parameter by fifteen minutes. In such an example, the apparatus adjusts the parameter by fifteen minutes in response to receiving continuous stroke input 152.

FIG. 1G illustrates a continuous stroke input 162 for adjustment in relation to an input area 161 according to at least one example embodiment. Continuous stroke input 162 relates to a continuous stroke input that comprises a first increasing adjustment input, prior to a decreasing magnitude adjustment input, prior to a second increasing adjustment input. In the example of FIG. 1G, mark 163 illustrates a point in continuous stroke input 162 associated with a first parameter adjustment, mark 164 illustrates a point in continuous stroke input 162 associated with an adjustment magnitude adjustment, and mark 165 illustrates a point in continuous stroke input 162 associated with a second parameter adjustment. Therefore, in response to receiving continuous stroke input 162, an apparatus may adjust a parameter by an adjustment magnitude, adjust the adjustment magnitude, and adjust the parameter by the adjustment magnitude. For example, in response to receiving continuous stroke input 162, the apparatus may adjust the parameter by ten, adjust the adjustment magnitude from ten to one, and adjust the parameter by one. In such an example, the apparatus adjusts the parameter by eleven in response to receiving continuous stroke 162.

FIGS. 2A-2E are diagrams illustrating a continuous stroke input for adjustment according to at least one example embodiment. The examples of FIGS. 2A-2E are merely examples of continuous stroke inputs, and do not limit the scope of the claims. For example, path of the input may vary, number of regions may vary, arrangement of regions may vary, size of regions may vary, orientation may vary, and/or the like.

In an example embodiment, an adjustment magnitude is set to a predetermined adjustment magnitude. The predetermined adjustment magnitude may be based, at least in part, on position of contact input of a continuous stroke input, such as contact input 642 of continuous stroke input 644 of FIG. 6C, comprising an adjustment input. For example, a first region of an input area may be associated with a first predetermined adjustment magnitude, and a second region of an input area may be associated with a second predetermined adjustment magnitude. In such an example, the first predetermined adjustment magnitude may be one hour and the second predetermined adjustment magnitude may be thirty minutes.

In an example embodiment, a region may be associated with at least part of a visual representation of a parameter. For example, a parameter relating to time may be represented on a touch display. A region of the touch display beneath the part of the representation indicating hour value of the parameter may be associated with a predetermined magnitude adjustment of one hour, and a region of the touch display beneath the part of the representation indicating hour value may be ten minutes. Although the diagrams illustrate regions by way of a dotted line, in an example embodiment, representation of a region may differ and/or be absent. For example, an apparatus may omit indication of a region.

FIG. 2A illustrates a continuous stroke input 202, in relation to regions 208 and 209 of input area 201, for adjustment according to at least one example embodiment. Continuous stroke input 202 may relate to an increasing adjustment input, with points along continuous stroke input 202 associated with an adjustment denoted by marks 203 and 204. The apparatus may determine to utilize a predetermined adjustment magnitude associated with region 208 based on determination that position of the contact input of continuous stroke input 202 coincides with at least part of region 208. The apparatus may utilize a predetermined adjustment magnitude associated with region 208 for performing the adjustments denoted by marks 203 and 204.

FIG. 2B illustrates a continuous stroke input 212, in relation to regions 218 and 219 of input area 211, for adjustment according to at least one example embodiment. Continuous stroke input 212 may relate to a decreasing adjustment input, with a point along continuous stroke input 212 associated with an adjustment denoted by mark 213. The apparatus may determine to utilize a predetermined adjustment magnitude associated with region 219 based on determination that position of the contact input of continuous stroke input 212 coincides with at least part of region 219. The apparatus may utilize a predetermined adjustment magnitude associated with region 219 for performing the adjustment denoted by mark 213.

FIG. 2C illustrates a continuous stroke input 222, in relation to regions 228 and 229 of input area 221, for adjustment according to at least one example embodiment. Continuous stroke input 222 may comprise a decreasing magnitude adjustment input with a point associated with an adjustment magnitude adjustment denoted by mark 223, prior to a decreasing adjustment input with a point associated with an adjustment denoted by mark 224. The apparatus may determine to utilize a predetermined adjustment magnitude associated with region 228 based on determination that position of the contact input of continuous stroke input 222 coincides with at least part of region 228. The apparatus may utilize a predetermined adjustment magnitude associated with region 228 for performing the adjustments denoted by marks 223 and 224. For example, in response to continuous stroke input 222, the apparatus may adjust the parameter by a decreased value of the predetermined adjustment magnitude associated with region 228. In an example embodiment, adjusting the adjustment magnitude is performed without regard for position of the magnitude adjustment input. For example, even though the magnitude adjustment input at least partially coincides with region 229, the adjustment of the adjustment magnitude may be performed without regard for the predetermined adjustment magnitude associated with region 229. In such an example, region 228 may have an associated predetermined adjustment magnitude of one thousand, and region 229 may have an associated predetermined adjustment magnitude of ten. In this example, the apparatus may adjust the magnitude adjustment by a factor of ten. Under such circumstances, continuous stroke input 222 would indicate a parameter adjustment by one hundred (being one thousand divided by ten), without regard for the predetermined adjustment magnitude of region 209 (ten) even though part of the magnitude adjustment input, and the entirety of the adjustment input coincide with region 209.

FIG. 2D illustrates a continuous stroke input for 232, in relation to regions 238 and 239 of input area 231, for adjustment according to at least one example embodiment. Continuous stroke input 232 may comprise an increasing adjustment input with a point associated with an adjustment denoted by mark 233, prior to a decreasing magnitude adjustment input with a point associated with an adjustment magnitude adjustment denoted by mark 234, prior to an increasing adjustment input with a point associated with an adjustment denoted by mark 235. The apparatus may determine to utilize a predetermined adjustment magnitude associated with region 238 based on determination that position of the contact input of continuous stroke input 232 coincides with at least part of region 238. The apparatus may utilize a predetermined adjustment magnitude associated with region 238 for performing the adjustments denoted by marks 233, 234, and 235. For example, in response to continuous stroke input 232, the apparatus may adjust the parameter by the predetermined adjustment magnitude associated with region 238 and a decreased value of the predetermined adjustment magnitude associated with region 238. For example, if the predetermined adjustment magnitude associated with region 238 is twelve hours, and the apparatus adjusts the adjustment magnitude from twelve hours to one hour in response to the magnitude adjustment input, the apparatus will adjust the parameter by 13 hours in response to continuous stroke input 232.

FIG. 2E illustrates a continuous stroke input 242, in relation to regions 248 and 249 of input area 241, for adjustment according to at least one example embodiment. Continuous stroke input 242 may comprise an increasing magnitude adjustment input with points associated with an adjustment magnitude adjustment denoted by marks 243 and 244. The apparatus may determine to utilize a predetermined adjustment magnitude associated with region 249 based on determination that position of the contact input of continuous stroke input 242 coincides with at least part of region 249. The apparatus may utilize a predetermined adjustment magnitude associated with region 249 for performing the adjustments denoted by marks 243 and 244. For example, in response to continuous stroke input 242, the apparatus may adjust the parameter by the predetermined adjustment magnitude associated with region 249. In an example embodiment, adjusting the parameter is performed without regard for position of the adjustment input. For example, even though the adjustment input, and the adjustment point denoted by mark 244, at least partially coincide with region 248, the adjustment of the parameter may be performed without regard for the predetermined adjustment magnitude associated with region 248. In such an example, region 249 may have an associated predetermined adjustment magnitude of one, and region 248 may have an associated predetermined adjustment magnitude of ten. In this example, the apparatus may adjust the parameter by two, without regard for the predetermined adjustment magnitude of region 248 (ten) even though part of the adjustment input coincides with region 248.

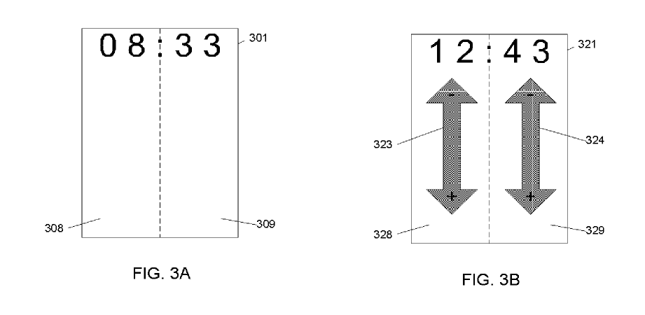

FIGS. 3A-3B are diagrams illustrating visual representations a parameter relating to time according to at least one example embodiment. The examples of FIGS. 3A-3B are merely examples, and do not limit the scope of the claims. For example, arrangement may vary, type of information may vary, size may vary, orientation may vary, and/or the like.

In an example embodiment, an apparatus may adjust a parameter relating to time. The parameter may relate to a time value, a time offset value, and/or the like. A time value may be a value representing a present, past, or future time. A time offset value may relate to a value representing duration of time. Such a duration may relate to time of an event, such as the setting of the time offset value. In an example embodiment, a time offset value may be a timer that expires upon passing of time equal to the time represented by the time offset value.

In an example embodiment, an apparatus may utilize a time related parameter in association with a profile setting. The apparatus may utilize a time related parameter to determine when to modify, set, change, and/or the like, a profile setting. For example, the parameter may indicate a time to switch to a profile setting, a time offset during which a profile setting should be active, and/or the like.

In an example embodiment, a profile setting relates to one or more settings, which control behavior of an apparatus. For example, a profile setting may comprise an audio setting, a visual setting, an interaction setting, and/or the like. An audio setting may relate to apparatus volume, an alert tone, a microphone setting, and/or the like. A visual setting may relate to display brightness, utilization of a background image, a screensaver, and/or the like. An interaction setting may relate to publication of presence, a call forwarding mode, utilization of a messaging account, and/or the like.

In an example embodiment, a user may desire to quickly set a time related profile setting. For example, the user may be in a distracting activity, a conversation, meeting, and/or the like. Under such circumstances, the user may desire to avoid having the interaction with the apparatus be an intrusion. Under such circumstances, the user may desire to perform input for adjustment similar as described with reference to FIGS. 1A-1G, and FIGS. 2A-2E. In another example, the user may desire to perform the input without viewing the apparatus. In such an example, the user may desire non-visual indication of adjustment, similar as described with reference to FIGS. 1A-1G. Under such circumstances, the user may be able to perform input and receive indication of adjustments performed by the apparatus without diverting visual attention from another task the user may be concurrently performing.

In an example embodiment, a user may desire to visually associate a parameter with an adjustment magnitude. For example, a user may desire to visually associate a region having an associated predetermined adjustment magnitude with a part of the parameter indicating the predetermined adjustment magnitude. For example, if the predetermined adjustment magnitude relates to an adjustment of one hour, the user may desire to visually associate part of the parameter associated with a measurement of hours with the region that corresponds to the predetermined adjustment magnitude.

FIG. 3A illustrates a visual representation of a parameter that provides a visual association between parts of the parameter and related regions 308 and 309 in relation to input area 301. In the example of FIG. 3A, the parameter is represented by visual representation of time value “08:33”. This visual representation is indicated such that the representation of hours coincides with region 308, and the representation of minutes coincides with region 309. The apparatus may utilize such a representation to indicate that a continuous stroke input having a contact input coinciding with region 308 relates to a predetermined adjustment magnitude on the order of hours. Such adjustment may relate to an adjustment of one or more hours. The apparatus may utilize such a representation to indicate that a continuous stroke input having a contact input coinciding with region 309 relates to a predetermined adjustment magnitude on the order of minutes. Such adjustment may relate to an adjustment of one or more minutes. The example of FIG. 3A illustrates a visual representation of the parameter absent adjustment indicators. For example, even though the visual representation of the parameter associates regions with parts of the parameter, the apparatus provides no indication prompting the user to adjust the parameter in any particular way.

FIG. 3B illustrates a visual representation of a parameter that provides a visual association between parts of the parameter and related regions 328 and 329 in relation to input area 321. The example of FIG. 3B, the parameter is represented by visual representation of time value “12:43”. This visual representation is indicated such that the representation of hours coincides with region 328, and the representation of minutes coincides with region 329. The apparatus may utilize such a representation to indicate that a continuous stroke input having a contact input coinciding with region 328 relates to a predetermined adjustment magnitude on the order of hours. Such adjustment may relate to an adjustment of one or more hours. The apparatus may utilize such a representation to indicate that a continuous stroke input having a contact input coinciding with region 329 relates to a predetermined adjustment magnitude on the order of minutes. Such adjustment may relate to an adjustment of one or more minutes. The example of FIG. 3B illustrates a visual representation of the parameter with adjustment indicators 323 and 324. Adjustment indicators may indicate adjustment axis, positive direction of adjustment axis, magnitude adjustment axis, positive direction of adjustment axis, and/or the like.

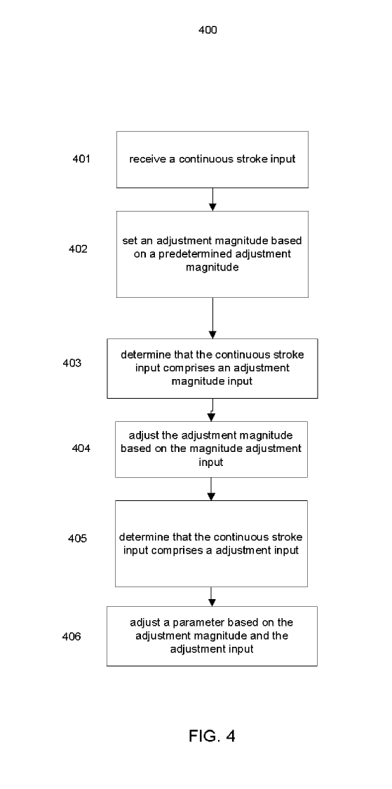

FIG. 4 is a flow diagram showing a set of operations 400 for parameter adjustment according to an example embodiment. An apparatus, for example electronic device 10 of FIG. 7 or a portion thereof, may utilize the set of operations 400. The apparatus may comprise means, including, for example processor 20 of FIG. 7, for performing the operations of FIG. 4. In an example embodiment, an apparatus, for example device 10 of FIG. 7, is transformed by having memory, for example memory 42 of FIG. 7, comprising computer code configured to, working with a processor, for example processor 20 of FIG. 7, cause the apparatus to perform set of operations 400.

At block 401, the apparatus receives indication of a continuous stroke input. The apparatus may receive indication of the continuous stroke input from a sensor, such as sensor 37 of FIG. 7, from a touch display, such as display 28 of FIG. 7, from a separate apparatus, and/or the like. The continuous stroke input may be similar as described with reference to FIGS. 1A-1G and FIGS. 2A-2E.

At block 402, the apparatus sets an adjustment magnitude based on a predetermined adjustment magnitude. The adjustment magnitude and the predetermined magnitude adjustment may be similar as described with reference to FIGS. 1A-1G and FIGS. 2A-2E.

At block 403, the apparatus determines that the continuous stroke input comprises an adjustment magnitude input, similar as described with reference to FIGS. 1A-1G and FIGS. 2A-2E.

At block 404, the apparatus adjusts the adjustment magnitude based on the magnitude adjustment input similar as described with reference to FIGS. 1A-1G and FIGS. 2A-2E.

At block 405, the apparatus determines that the continuous stroke input comprises an adjustment input similar as described with reference to FIGS. 1A-1G and FIGS. 2A-2E.

At block 406, the apparatus adjusts a parameter based on the adjustment magnitude and the adjustment input similar as described with reference to FIGS. 1A-1G and FIGS. 2A-2E.

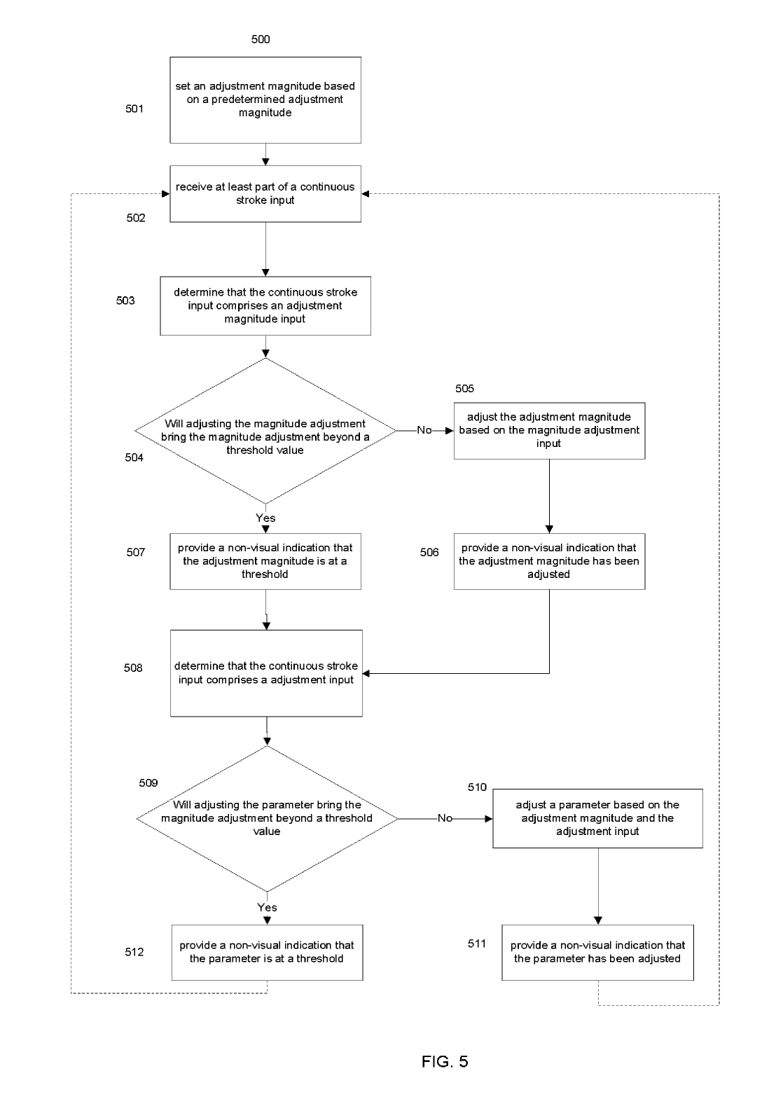

FIG. 5 is a flow diagram showing a set of operations 500 for parameter adjustment according to an example embodiment. An apparatus, for example electronic device 10 of FIG. 7 or a portion thereof, may utilize the set of operations 500. The apparatus may comprise means, including, for example processor 20 of FIG. 7, for performing the operations of FIG. 5. In an example embodiment, an apparatus, for example device 10 of FIG. 7, is transformed by having memory, for example memory 42 of FIG. 7, comprising computer code configured to, working with a processor, for example processor 20 of FIG. 7, cause the apparatus to perform set of operations 500.

At block 501, the apparatus sets an adjustment magnitude based on a predetermined adjustment magnitude similar as described with reference to block 402 of FIG. 4.

At block 502, the apparatus receives at least part of a continuous stroke input similar as described with reference to block 401 of FIG. 4. The apparatus may receive the at least part of the continuous stroke input prior to the release input of the continuous stroke input.

At block 503, the apparatus determines that the continuous stroke input comprises an adjustment magnitude input similar as described with reference to block 403 of FIG. 4.

At block 504, the apparatus determines whether adjusting the magnitude adjustment will bring the magnitude adjustment beyond a threshold value. The threshold determination may be similar as described with reference to FIGS. 1A-1G. If the apparatus determines that adjusting the magnitude adjustment will bring the magnitude adjustment beyond a threshold value, the flow proceeds to block 507. Otherwise, the flow proceeds to block 505.

If at block 504, the apparatus determined that adjusting the magnitude adjustment will not bring the magnitude adjustment beyond a threshold value, at block 505, the apparatus adjusts the adjustment magnitude based on the magnitude adjustment input similar as described with reference to block 404 of FIG. 4. The flow proceeds to block 506.

At block 506, the apparatus provides a non-visual indication that the adjustment magnitude has been adjusted, similar as described with reference to FIGS. 1A-1G. The flow proceeds to block 508.

If at block 504, the apparatus determined that adjusting the magnitude adjustment will bring the magnitude adjustment beyond a threshold value, at block 507, the apparatus provides a non-visual indication that the adjustment magnitude is at a threshold, similar as described with reference to FIGS. 1A-1G.

At block 508, the apparatus determines that the continuous stroke input comprises an adjustment input, similar as described with reference to block 405 of FIG. 4.

At block 509, the apparatus determines whether adjusting the parameter will bring the magnitude adjustment beyond a threshold value. The threshold determination may be similar as described with reference to FIGS. 1A-1G. If the apparatus determines that adjusting the parameter will bring the parameter beyond a threshold value, the flow proceeds to block 512. Otherwise, the flow proceeds to block 510.

If, at block 509, the apparatus determines whether adjusting the parameter will not bring the magnitude adjustment beyond a threshold value, at block 510, the apparatus adjusts a parameter based on the adjustment magnitude and the adjustment input, similar as described with reference to block 406 of FIG. 4. Flow proceeds to block 511.

At block 511, the apparatus provides a non-visual indication that the parameter has been adjusted, similar as described with reference to FIGS. 1A-1G.

If, at block 509, the apparatus determines whether adjusting the parameter will not bring the magnitude adjustment beyond a threshold value, at block 512, the apparatus provides a non-visual indication that the parameter is at a threshold, similar as described with reference to FIGS. 1A-1G.

In an example embodiment, the apparatus may continually receive parts of the continuous stroke input and perform at least part of the set of operations 500. Under such circumstances, the flow may proceed from block 511 to block 502, and from block 512 to block 502.

For example, the apparatus may set an adjustment magnitude based, at least in part, on a predetermined adjustment magnitude. The apparatus may receive an indication of part of a continuous stroke input, and determine that the continuous stroke input comprises a first adjustment input based at least in part on identifying that the first adjustment input is substantially parallel to an adjustment axis. The apparatus may adjust a parameter based, at least in part, on the adjustment magnitude and the first adjustment input. The apparatus may receive indication of another part of a continuous stroke input, and determine that the continuous stroke input comprises a first adjustment magnitude input based, at least in part, on identifying that the first adjustment magnitude input is substantially parallel to a magnitude adjustment axis. The apparatus may adjust the adjustment magnitude based, at least in part, on the magnitude adjustment input. The apparatus may receive an indication of yet another part of a continuous stroke input, and determine that the continuous stroke input comprises a second adjustment input and adjust the parameter based, at least in part, on the adjustment magnitude and the second adjustment input.

FIGS. 6A-6E are diagrams illustrating input associated with a touch display, for example from display 28 of FIG. 7, according to at least one example embodiment. In FIGS. 6A-6E, a circle represents an input related to contact with a touch display, two crossed lines represent an input related to releasing a contact from a touch display, and a line represents input related to movement on a touch display. Although the examples of FIGS. 6A-6E indicate continuous contact with a touch display, there may be a part of the input that fails to make direct contact with the touch display. Under such circumstances, the apparatus may, nonetheless, determine that the input is a continuous stroke input. For example, the apparatus may utilize proximity information, for example information relating to nearness of an input implement to the touch display, to determine part of a touch input.

In the example of FIG. 6A, input 600 relates to receiving contact input 602 and receiving a release input 604. In this example, contact input 602 and release input 604 occur at the same position. In an example embodiment, an apparatus utilizes the time between receiving contact input 602 and release input 604. For example, the apparatus may interpret input 600 as a tap for a short time between contact input 602 and release input 604, as a press for a longer time between contact input 602 and release input 604, and/or the like.

In the example of FIG. 6B, input 620 relates to receiving contact input 622, a movement input 624, and a release input 626. Input 620 relates to a continuous stroke input. In this example, contact input 622 and release input 626 occur at different positions. Input 620 may relate to dragging an object from one position to another, to moving a scroll bar, to panning a virtual screen, to drawing a shape, and/or the like. In an example embodiment, an apparatus interprets input 620 based at least in part on the speed of movement 624. For example, if input 620 relates to panning a virtual screen, the panning motion may be small for a slow movement, large for a fast movement, and/or the like. In another example embodiment, an apparatus interprets input 620 based at least in part on the distance between contact input 622 and release input 626. For example, if input 620 relates to a scaling operation, such as resizing a box, the scaling may relate to the distance between contact input 622 and release input 626. An apparatus may interpret the input before receiving release input 626. For example, the apparatus may evaluate a change in the input, such as speed, position, and/or the like. In such an example, the apparatus may perform one or more determinations based upon the change in the touch input. In such an example, the apparatus may modify a text selection point based at least in part on the change in the touch input.

In the example of FIG. 6C, input 640 relates to receiving contact input 642, a movement input 644, and a release input 646 as shown. Input 640 relates to a continuous stroke input. In this example, contact input 642 and release input 646 occur at different positions. Input 640 may relate to dragging an object from one position to another, to moving a scroll bar, to panning a virtual screen, to drawing a shape, and/or the like. In an example embodiment, an apparatus interprets input 640 based at least in part on the speed of movement 644. For example, if input 640 relates to panning a virtual screen, the panning motion may be small for a slow movement, large for a fast movement, and/or the like. In another example embodiment, an apparatus interprets input 640 based at least in part on the distance between contact input 642 and release input 646. For example, if input 640 relates to a scaling operation, such as resizing a box, the scaling may relate to the distance between contact input 642 and release input 646. In still another example embodiment, the apparatus interprets the position of the release input. In such an example, the apparatus may modify a text selection point based at least in part on the change in the touch input.

In the example of FIG. 6D, input 660 relates to receiving contact input 662, and a movement input 664, where contact is released during movement. Input 660 relates to a continuous stroke input. Input 660 may relate to dragging an object from one position to another, to moving a scroll bar, to panning a virtual screen, to drawing a shape, and/or the like. In an example embodiment, an apparatus interprets input 660 based at least in part on the speed of movement 664. For example, if input 660 relates to panning a virtual screen, the panning motion may be small for a slow movement, large for a fast movement, and/or the like. In another example embodiment, an apparatus interprets input 660 based at least in part on the distance associated with the movement input 664. For example, if input 660 relates to a scaling operation, such as resizing a box, the scaling may relate to the distance of the movement input 664 from the contact input 662 to the release of contact during movement.

In an example embodiment, an apparatus may receive multiple touch inputs at coinciding times. For example, there may be a tap input at a position and a different tap input at a different location during the same time. In another example there may be a tap input at a position and a drag input at a different position. An apparatus may interpret the multiple touch inputs separately, together, and/or a combination thereof. For example, an apparatus may interpret the multiple touch inputs in relation to each other, such as the distance between them, the speed of movement with respect to each other, and/or the like.

In the example of FIG. 6E, input 680 relates to receiving contact inputs 682 and 688, movement inputs 684 and 660, and release inputs 686 and 662. Input 620 relates to two continuous stroke inputs. In this example, contact input 682 and 688, and release input 686 and 662 occur at different positions. Input 680 may be characterized as a multiple touch input. Input 680 may relate to dragging an object from one position to another, to moving a scroll bar, to panning a virtual screen, to drawing a shape, to indicating one or more user selected text positions and/or the like. In an example embodiment, an apparatus interprets input 680 based at least in part on the speed of movements 684 and 660. For example, if input 680 relates to zooming a virtual screen, the zooming motion may be small for a slow movement, large for a fast movement, and/or the like. In another example embodiment, an apparatus interprets input 680 based at least in part on the distance between contact inputs 682 and 688 and release inputs 686 and 662. For example, if input 680 relates to a scaling operation, such as resizing a box, the scaling may relate to the collective distance between contact inputs 682 and 688 and release inputs 686 and 662.

In an example embodiment, the timing associated with the apparatus receiving contact inputs 682 and 688, movement inputs 684 and 660, and release inputs 686 and 662 varies. For example, the apparatus may receive contact input 682 before contact input 688, after contact input 688, concurrent to contact input 688, and/or the like. The apparatus may or may not utilize the related timing associated with the receiving of the inputs. For example, the apparatus may utilize an input received first by associating the input with a preferential status, such as a primary selection point, a starting position, and/or the like. In another example, the apparatus may utilize non-concurrent inputs as if the apparatus received the inputs concurrently. In such an example, the apparatus may utilize a release input received first the same way that the apparatus would utilize the same input if the apparatus had received the input second.

Even though an aspect related to two touch inputs may differ, such as the direction of movement, the speed of movement, the position of contact input, the position of release input, and/or the like, the touch inputs may be similar. For example, a first touch input comprising a contact input, a movement input, and a release input, may be similar to a second touch input comprising a contact input, a movement input, and a release input, even though they may differ in the position of the contact input, and the position of the release input.

FIG. 7 is a block diagram showing an apparatus, such as an electronic device 10, according to an example embodiment. It should be understood, however, that an electronic device as illustrated and hereinafter described is merely illustrative of an electronic device that could benefit from embodiments of the invention and, therefore, should not be taken to limit the scope of the invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, media players, cameras, video recorders, global positioning system (GPS) devices and other types of electronic systems, may readily employ embodiments of the invention. Moreover, the apparatus of an example embodiment need not be the entire electronic device, but may be a component or group of components of the electronic device in other example embodiments.

Furthermore, devices may readily employ embodiments of the invention regardless of their intent to provide mobility. In this regard, even though embodiments of the invention are described in conjunction with mobile communications applications, it should be understood that embodiments of the invention may be utilized in conjunction with a variety of other applications, both in the mobile communications industries and outside of the mobile communications industries.

The electronic device 10 may comprise an antenna, (or multiple antennae), a wired connector, and/or the like in operable communication with a transmitter 14 and a receiver 16. The electronic device 10 may further comprise a processor 20 or other processing circuitry that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with wireline protocols, such as Ethernet, digital subscriber line (DSL), asynchronous transfer mode (ATM), second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

As used in this application, the term ‘circuitry’ refers to all of the following: hardware-only implementations (such as implementations in only analog and/or digital circuitry) and to combinations of circuits and software and/or firmware such as to a combination of processor(s) or portions of processor(s)/software including digital signal processor(s), software, and memory(ies) that work together to cause an apparatus, such as a mobile phone or server, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware. The term “circuitry” would also cover, for example, a baseband integrated circuit or applications processor integrated circuit for a mobile phone or a similar integrated circuit in a cellular network device or other network device.

Processor 20 may comprise means, such as circuitry, for implementing audio, video, communication, navigation, logic functions, and/or the like, as well as for implementing embodiments of the invention including, for example, one or more of the functions described in conjunction with FIGS. 1A-7. For example, processor 20 may comprise means, such as a digital signal processor device, a microprocessor device, various analog to digital converters, digital to analog converters, processing circuitry and other support circuits, for performing various functions including, for example, one or more of the functions described in conjunction with FIGS. 1A-7. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment including, for example, one or more of the functions described in conjunction with FIGS. 1A-7. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise means, such as one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. Display 28 may display two-dimensional information, three-dimensional information and/or the like.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise a memory device including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 1A-7. For example, the memories may comprise an identifier, such as an international mobile equipment identification (IMEI) code, which may uniquely identify the electronic device 10.

Electronic device 10 may comprise one or more sensor 37. Sensor 37 may comprise a light sensor, a proximity sensor, a motion sensor, a location sensor, and/or the like. For example, sensor 37 may comprise one or more light sensors at various locations on the device. In such an example, sensor 37 may provide sensor information indicating an amount of light perceived by one or more light sensors. Such light sensors may comprise a photovoltaic element, a photoresistive element, a charge coupled device (CCD), and/or the like. In another example, sensor 37 may comprise one or more proximity sensors at various locations on the device. In such an example, sensor 37 may provide sensor information indicating proximity of an object, a user, a part of a user, and/or the like, to the one or more proximity sensors. Such proximity sensors may comprise capacitive measurement, sonar measurement, radar measurement, and/or the like.

Although FIG. 7 illustrates an example of an electronic device that may utilize embodiments of the invention including those described and depicted, for example, in FIGS. 1A-7, electronic device 10 of FIG. 7 is merely an example of a device that may utilize embodiments of the invention.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 7. A computer-readable medium may comprise a computer-readable storage medium that may be any tangible media or means that can contain or store the instructions for use by or in connection with an instruction execution system, apparatus, or device, such as a computer.

If desired, the different functions discussed herein may be performed in a different order and/or concurrently with each other. For example, in FIG. 4, block 403 may be performed after block 405. Furthermore, if desired, one or more of the above-described functions may be optional or may be combined. For example, blocks 506 and 507 of FIG. 5 may be optional and/or combined with block 504.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

1. An apparatus, comprising:
a processor;
memory including computer program code, the memory and the computer program code configured to, working with the processor, cause the apparatus to perform at least the following:
receiving, at least part of, an indication of a continuous stroke input;
setting an adjustment magnitude based, at least in part, on a predetermined adjustment magnitude;
determining that the continuous stroke input comprises a first adjustment magnitude input based, at least in part, on identifying that the first adjustment magnitude input is substantially parallel to a magnitude adjustment axis;
adjusting the adjustment magnitude based, at least in part, on the magnitude adjustment input;
determining that the continuous stroke input comprises a first adjustment input based at least in part on identifying that the first adjustment input is substantially parallel to an adjustment axis, the adjustment axis being substantially orthogonal to the magnitude adjustment axis; and
adjusting a parameter based, at least in part, on the adjustment magnitude and the first adjustment input.

2. The apparatus of claim 1, wherein the first magnitude adjustment input is prior to the first adjustment input.

3. The apparatus of claim 1, wherein adjusting the adjustment magnitude comprises at least one of increasing the adjustment magnitude based on determination that the magnitude adjustment input is in a substantially positive direction along the magnitude adjustment axis, or decreasing the adjustment magnitude based on determination that the magnitude adjustment input is in a substantially opposite direction to the positive direction along the magnitude adjustment axis.

4. The apparatus of claim 1, wherein adjusting the adjustment magnitude is based, at least in part, on at least one of speed of the magnitude adjustment input, or length of the magnitude adjustment input.

5. The apparatus of claim 1, wherein adjusting the adjustment magnitude is performed without regard for position of the magnitude adjustment input.

6. The apparatus of claim 1, wherein adjusting the magnitude adjustment is performed in response to determination that adjusting the magnitude adjustment will not bring the magnitude adjustment beyond a threshold value.

7. The apparatus of claim 1, wherein adjusting the parameter comprises at least one of increasing the parameter based on determination that the adjustment input is in a substantially positive direction along the adjustment axis, or decreasing the parameter based on determination that the adjustment input is in a substantially opposite direction to the positive direction along the adjustment axis.

8. The apparatus of claim 1, wherein adjusting the parameter is based, at least in part, on at least one of speed of the adjustment input, or length of the adjustment input.

9. The apparatus of claim 1, wherein adjusting the parameter comprises adjusting the parameter by a multiple of the first adjustment magnitude.

10. The apparatus of claim 1, wherein adjusting the parameter is performed without regard for position of the adjustment input.

11. The apparatus of claim 1, wherein adjusting the parameter is performed in response to determination that adjusting the parameter will not bring the magnitude adjustment beyond a threshold value.

12. The apparatus of claim 1, wherein the predetermined adjustment magnitude is based, at least in part, on position of contact input of the continuous stroke input.

13. The apparatus of claim 1, wherein the memory and the computer program code are further configured to, working with the processor, cause the apparatus to further perform at least providing a non-visual indication that the adjustment magnitude has been adjusted.

14. The apparatus of claim 1, wherein the memory and the computer program code are further configured to, working with the processor, cause the apparatus to further perform at least providing a non-visual indication that the parameter has been adjusted.

15. The apparatus of claim 1, wherein the memory and the computer program code are further configured to, working with the processor, cause the apparatus to further perform at least determining that the continuous stroke input comprises a second adjustment input prior to the first magnitude adjustment input and adjusting the parameter based, at least in part, on the adjustment magnitude and the first adjustment input.

16. The apparatus of claim 1, wherein the parameter relates to time.

17. The apparatus of claim 16, wherein the time relates to a profile setting.

18. The apparatus of claim 1, wherein the apparatus is a mobile device.

19. A method comprising:
receiving, at least part of, an indication of a continuous stroke input;
setting an adjustment magnitude based, at least in part, on a predetermined adjustment magnitude;
determining that the continuous stroke input comprises a first adjustment magnitude input based, at least in part, on identifying that the first adjustment magnitude input is substantially parallel to a magnitude adjustment axis;
adjusting the adjustment magnitude based, at least in part, on the magnitude adjustment input;
determining that the continuous stroke input comprises a first adjustment input based at least in part on identifying that the first adjustment input is substantially parallel to an adjustment axis, the adjustment axis being substantially orthogonal to the magnitude adjustment axis; and
adjusting a parameter based, at least in part, on the adjustment magnitude and the first adjustment input.

20. A computer-readable medium encoded with instructions that, when executed by a computer, perform:
receiving, at least part of, an indication of a continuous stroke input;
setting an adjustment magnitude based, at least in part, on a predetermined adjustment magnitude;
determining that the continuous stroke input comprises a first adjustment magnitude input based, at least in part, on identifying that the first adjustment magnitude input is substantially parallel to a magnitude adjustment axis;
adjusting the adjustment magnitude based, at least in part, on the magnitude adjustment input;
determining that the continuous stroke input comprises a first adjustment input based at least in part on identifying that the first adjustment input is substantially parallel to an adjustment axis, the adjustment axis being substantially orthogonal to the magnitude adjustment axis; and
adjusting a parameter based, at least in part, on the adjustment magnitude and the first adjustment input.
